(19) United States
(12) Patent Application Publication
(10) Pub. No.: US 2023/0394250 A1
(43) Pub. Date: Dec. 7, 2023

(54) METHOD AND SYSTEM FOR CROSS-LINGUAL ADAPTATION USING DISENTANGLED SYNTAX AND SHARED CONCEPTUAL LATENT SPACE

(71) Applicant: Gnani Innovations Private Limited, Bengaluru (IN)

(72) Inventors: Armaan Puri, Bengaluru (IN); Bharath Shankar, Bengaluru (IN)

(21) Appl. No.: 18/327,903

(22) Filed: Jun. 2, 2023

(30) Foreign Application Priority Data
Jun. 2, 2022 (IN) 202241031712

(51) Int. Cl. G06F 40/58; G06F 40/211; G06F 40/30

(52) U.S. Cl. CPC G06F 40/58; G06F 40/211; G06F 40/30

(57) ABSTRACT

Present disclosure generally relates to machine translation systems, and particularly to method and system for cross-lingual adaptation using disentangled syntax and shared conceptual latent space for low-resource natural languages. Method includes converting multi-lingual sentences received from user, to linearized constituency parse tree and mask leaf nodes in linearized constituency parse tree to separate semantic information in multi-lingual sentences. Method includes passing linearized constituency parse tree with masked leaf nodes, to syntactic encoder for disentangling syntactic information in multi-lingual sentences. Method includes determining, from syntactic information, if multi-lingual sentences include new language to be learned which includes new script relatively to pre-existing language in language model and unique script with similarities in sentence structure corresponding to pre-existing language. Method includes transliterating syntactic information to pre-existing language, determining conceptual similarity between new language and pre-existing language, and outputting conceptual understanding based on determined conceptual similarity between new language and pre-existing language.

### CROSS REFERENCE TO RELATED APPLICATIONS

The present application claims the benefit of Indian Patent Application No. 202241031712 filed on Jun. 2, 2022, the contents of which are incorporated herein by reference in their entirety.

### FIELD OF INVENTION

The embodiments of the present disclosure generally relate to cross-lingual language understanding/adaptation systems. More particularly, the present disclosure relates to a method and a system for cross-lingual adaptation using disentangled syntax and shared conceptual latent space for low-resource natural languages.

### BACKGROUND

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of the prior art.

Generally, creation of interpretable cross-lingual models in low-resource scenarios may be essential to increase the breadth and practical utility of NLP capabilities. While present multilingual Language Models (LMs) demonstrate significant generalization across languages, the large volumes of data required may remain a challenge compounded further by limitations in transfer learning approaches. Certain methodologies addressed both these concerns by providing a low resource language adaptation paradigm that utilizes language relatedness and word embedding alignment. Besides language proximity, the importance of explicit word embedding alignment may also be established, towards which there has been significant past work. A parallel research direction may be concept-based learning to improve interpretability and causality beyond statistical correlation. Lack of explain-ability and spurious correlations may have led to concept-based neuro-symbolic methods on various tasks. A conventional method may disclose conceptual learning for low resource classification to leverage conceptual learning in a low resource setting, and show impressive results with and without additional annotation. Furthermore, a common way of explicitly storing and leveraging concepts is through knowledge graphs, which concretely define relations between common sense concepts and events, respectively. However, language models may also show implicit concept storing capability as brought out in recent work, showing evidence of reasoning and memorization, and also demonstrating inherent common-sense capability along with work showing retrievable entity representations and related facts.

The conventional method, such as a semi-supervised framework for transferable Named Entity Recognition (NER) may disentangle domain-invariant latent variables and domain-specific latent variables. The domain-specific information may be integrated with the domain-specific latent variables by using a domain predictor. In another conventional method a statistical translation systems based on syntax skeleton may be disclosed, in which syntactic translation rule carries out translation and long-range to syntax skeleton are asked, the vocabulary translation and sequencing of low level are handled using the rule of the non-syntactic translation system. In another conventional method, a machine translation system and a machine translation method based on a syntactic analysis and hierarchical model may be disclosed. The machine translation system comprises a word alignment module, a phrase extraction module, a part-of-speech and syntax tagging module, a syntax-based non-contiguous phrase extraction module, and a non-contiguous-phrase-based translation module, and a grading output module. In the machine translation system and the machine-translation method, syntactic analysis is carried out based on a general contiguous-phrase-based machine translation model, so that a syntax-based phrase rule base is extracted from a bilingual sentence alignment text, the problem of non-continuous fixed collocation of the context of the whole sentence is solved, and the invention accords with the syntactic characteristics of a language. The translation is carried out based on a non-contiguous phrase rule base and a phrase alignment table, and a translation result is graded based on an assessment model, so a translation effect is effectively improved. In yet another conventional method, a framework such as a Decomposable Variational Autoencoder (DecVAE) to disentangle syntax and semantics by using total correlation penalties of Kullback-Leibler (KL) divergences may be disclosed.

Conventional methods seeking to distinguish between syntax and semantics rely on fine-grained training objectives to encourage the model to distinguish between syntax and semantics. To this end, Variational Auto Encoders (VAEs) may have been a popular design choice. The VAEs' ability to use disparate latent spaces to reconstruct the input can be used to enforce separated representation learning in terms of syntax and semantics (via a multi-task objective). However, separating out linguistic information and conceptual meaning (expressed through semantics) for representation learning remains under-explored. Conventional methods may focus more on monolingual generative applications such as a paraphrasing and style transfer, similar to the objective in voice cloning applications. Further, the conventional methods may not effectively learn, interpret and align the components (i.e., syntax, semantics, and concepts), disentanglement of the word embedding space which may address the limitations in current cross-lingual transfer paradigms. Furthermore, the conventional methods may not disentangle word embeddings across languages such that language relatedness informs the syntactical space, without confounding the semantic/conceptual space to improve the potential for interpretable, unambiguous learning.

Therefore, there is a need for a method and a system for solving the shortcomings of the current technologies, by providing a method and a system for cross-lingual adaptation using disentangled syntax and shared conceptual latent space for low-resource natural languages, which creates a low-resource, interpretable, concept-based, language adaptation paradigm that utilizes embedding disentanglement into concepts and syntax.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may be for cross-lingual adaptation using disentangled syntax and shared conceptual latent space for low-resource natural languages.

It is an object of the present disclosure to provide a method and a system for cross-lingual adaptation using disentangled syntax and shared conceptual latent space for low-resource natural languages.

It is another object of the present disclosure to provide a method and a system for extracting a language invariant semantic and syntax space from cross-lingual embeddings of a pre-trained model (for languages already included), based on syntactic-semantic space disentanglement.

It is another object of the present disclosure to improve low-resource task performance, especially new language adaptation.

It is another object of the present disclosure to enable a shared semantic space to be generalizable in terms of monolingual and multilingual tasks, and enables a systematic generalization.

It is another object of the present disclosure to provide a constituency tree approach by converting (multilingual) input sentences to linearized constituency parse trees, and masking leaf nodes in the parse tree to ensure semantic information is separated, and passed to the syntactic encoder.

It is another object of the present disclosure to provide a multi-task approach in low resource scenarios, in which creating a constituency tree is not possible.

It is another object of the present disclosure to enable a language adaptation of the same script, in which the new language to be learned has the same script as the pre-existing language in the language model, and a different script.

It is another object of the present disclosure to provide enable transliteration and pseudo translation for the different scripts, to help alignment loss to adjust the syntactic encoder for the new language by building on past knowledge of a known, related language.

It is another object of the present disclosure to address low resource language transfer, word embedding alignment for improved cross-lingual performance, generalizable (language invariant) concept learning in cross-lingual models, and systematic generalization in neural networks using the disentangled syntactical (language-specific) and conceptual (language invariant) latent space learning and leveraging language relatedness and conceptual similarity. This enables efficient, interpretable language adaptation on a pre-trained language model.

It is yet another object of the present disclosure to enable the use of concept/semantic matching between parallel multilingual corpora while leveraging language relatedness (syntactically related) to learn low-resource language syntax. Such a disentangled cross-lingual learning paradigm has the potential to also improve downstream tasks like Question Answering (QA) and natural language inference (NLI) by directly influencing word embedding alignment, compositional generalization, and language invariant conceptual understanding.

In an aspect, the present disclosure provides a method for cross-lingual adaptation using disentangled syntax and shared conceptual latent space for low-resource natural languages. The method includes converting one or more multi-lingual sentences received from a user, to one or more linearized constituency parse trees. The linearized constituency parse trees include one or more leaf nodes. Further, the method includes masking the one or more leaf nodes in the linearized constituency parse tree to separate semantic information in the one or more multi-lingual sentences. Furthermore, the method includes passing the linearized constituency parse tree with the masked one or more leaf nodes, to a syntactic encoder for disentangling syntactic information in the one or more multi-lingual sentences. Thereafter, the method includes determining, from the syntactic information, if the one or more multi-lingual sentences comprise a new language to be learned, and the new language comprises at least one of a new script relatively to a pre-existing language in a language model and a unique script with similarities in sentence structure corresponding to the pre-existing language. Further, the method includes transliterating, when the new language to be learned comprises the unique script, the syntactic information to the pre-existing language. The transliteration includes applying an adaptation process to the transliteration and a pseudo translation for the new language adaptation in a low-resource scenario. Thereafter, the method includes determining a conceptual similarity between the new language and the pre-existing language, upon transliteration. Further, the method includes outputting a conceptual understanding based on the determined conceptual similarity between the new language and the pre-existing language.

In an embodiment, when the linearized constituency parse tree is not converted for low-resource natural languages, the sentence is directly passed to the syntactic encoder with auxiliary loss functions for disentanglement.

In an embodiment, the transliteration and pseudo translation are performed to adjust the syntactic encoder to alignment loss for the new language, by building on a historical knowledge of a known language, and a related language.

In an embodiment, the semantic information is held constant as the representation is already language invariant, which is used to reconstruct a sentence in the new language by learning respective syntactic information of the new language.

In an embodiment, the auxiliary loss functions are based on marginal log-likelihood cross-lingual reconstruction and posterior distribution in the known language.

In an embodiment, the natural languages are suited using a modified attentive code position loss, wherein the natural languages are aligned using a syntactic attention mechanism.

In an embodiment, for the new language, specific linguistic rules/features inform syntax adaptation, and semantic space is used to align conceptual understanding.

In an embodiment, the disentangled semantic information is language invariant and the syntactic information is language-specific, which is based on a pre-trained cross-lingual language model.

In another aspect, the present disclosure provides a disentangled system for cross-lingual adaptation using disentangled syntax and shared conceptual latent space for low-resource natural languages. The disentangled system converts one or more multi-lingual sentences received from a user, to one or more linearized constituency parse trees. The linearized constituency parse trees include one or more leaf nodes. Further, the system masks one or more leaf nodes in the linearized constituency parse tree to separate semantic information in one or more multi-lingual sentences. Furthermore, the system passes the linearized constituency parse tree with the masked one or more leaf nodes, to a syntactic encoder for disentangling syntactic information in the one or more multi-lingual sentences. Thereafter, the system determines, from the syntactic information, if the one or more multi-lingual sentences include a new language to be learned, and the new language comprises at least one of a new script relatively to a pre-existing language in a language model and a unique script with similarities in sentence structure corresponding to the pre-existing language. Further, the system transliterates, when the new language to be learned comprises the unique script, the syntactic information to the pre-existing language. The transliteration includes applying an adaptation process to the transliteration and a pseudo translation for the new language adaptation in a low-resource scenario. Furthermore, the system determines a conceptual similarity between the new language and the pre-existing language, upon transliteration. Further, the system outputs a conceptual understanding based on the determined conceptual similarity between the new language and the pre-existing language.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that the invention of such drawings includes the invention of electrical components, electronic components, or circuitry commonly used to implement such components.

FIG. 1 illustrates an exemplary block diagram representation of a network architecture implementing a proposed system for cross-lingual adaptation using disentangled syntax and shared conceptual latent space for low-resource natural languages, according to embodiments of the present disclosure.

FIG. 2 illustrates an exemplary detailed block diagram representation of the proposed system, according to embodiments of the present disclosure.

FIG. 3 illustrates a flow chart depicting a method of cross-lingual adaptation using disentangled syntax and shared conceptual latent space for low-resource natural languages, according to embodiments of the present disclosure.

FIG. 4 illustrates a hardware platform for the implementation of the disclosed system according to embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of the semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present provide a method and a system for cross-lingual adaptation using disentangled syntax and shared conceptual latent space for low-resource natural languages. The present disclosure provides a method and a system for extracting a language invariant semantic and syntax space from cross-lingual embeddings of a pre-trained model (for languages already included), based on syntactic-semantic space disentanglement. The present disclosure improves low-resource task performance, especially new language adaptation. The present disclosure enables a shared semantic space to be generalizable in terms of monolingual and multilingual tasks, and enables a systematic generalization. The present disclosure provides a constituency tree approach by converting (multilingual) input sentences to linearized constituency parse trees, and masks leaf nodes in the parse tree to ensure semantic information is separated, passed to the syntactic encoder.

Embodiments of the present disclosure also provide a multi task approach in low resource scenarios, in which creating a constituency tree is not possible. The present disclosure enables a language adaptation of the same script, in which the new language to be learned has the same script as the pre-existing language in the language model, and a different script. The present disclosure enables transliteration and pseudo translation for the different script, to help alignment loss to adjust the syntactic encoder for the new language by building on past knowledge of a known, related language. The present disclosure addresses low resource language transfer, word embedding alignment for improved cross-lingual performance, generalizable (language invariant) concept learning in cross-lingual models, and systematic generalization in neural networks using the disentangled syntactical (language-specific) and conceptual (language invariant) latent space learning and leveraging language relatedness and conceptual similarity. This enables efficient, interpretable language adaptation on a pre-trained language model. The present disclosure enables the use of concept/semantic matching between parallel multilingual corpora while leveraging language relatedness (syntactically related) to learn low-resource language syntax. Such a disentangled cross-lingual learning paradigm has the potential to also improve downstream tasks like Question Answering (QA) and natural language inference (NLI) by directly influencing word embedding alignment, compositional generalization, and language invariant conceptual understanding.

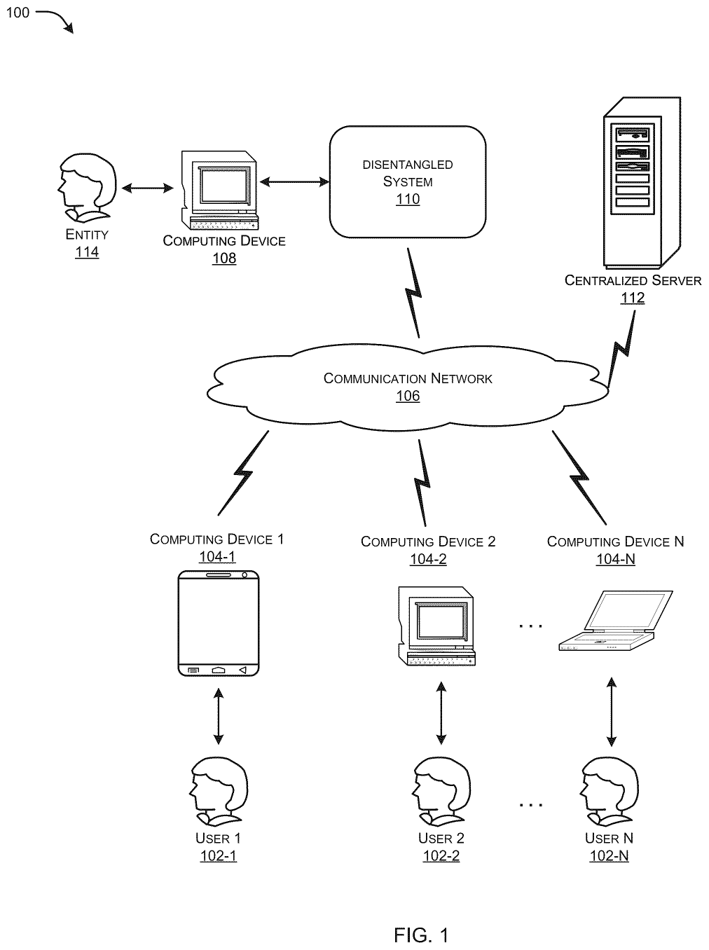

FIG. 1 illustrates an exemplary block diagram representation of a network architecture 100 implementing a proposed disentangled system 110 for cross-lingual adaptation using disentangled syntax and shared conceptual latent space for low-resource natural languages, according to embodiments of the present disclosure. The network architecture 100 may include a first computing device 104, a second computing device 108, the disentangled system 110 (hereinafter referred to as system 110), and a centralized server 112. The system 110 may be connected to the centralized server 112 via a communication network 106. The centralized server 112 may include, but are not limited to, a stand-alone server, a remote server, a cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable to transfer data between entities of that network such as, but are not limited to, a carrier network including a circuit-switched network, a public switched network, a Content Delivery Network (CDN) network, a Long-Term Evolution (LTE) network, a New Radio (NR), a Global System for Mobile Communications (GSM) network and a Universal Mobile Telecommunications System (UMTS) network, an Internet, intranets, Local Area Networks (LANs), Wide Area Networks (WANs), mobile communication networks, combinations thereof, and the like.

The system 110 may be implemented by way of a single device or a combination of multiple devices that may be operatively connected or networked together. For instance, the system 110 may be implemented by way of a standalone device such as the centralized server 112, and the like. In another instance, the system 110 may be implemented in/associated with an electronic device (not shown in FIG. 1) or the centralized server 112. In yet another instance, the system 110 may be implemented in/associated with respective computing device 104-1, 104-2, . . . , 104-N (individually referred to as computing device 104, and collectively referred to as computing devices 104), associated with one or more users 102-1, 102-2, . . . , 102-N (individually referred to as user 102, and collectively referred to as users 102). In such a scenario, the system 110 may be replicated in each of the computing devices 104. The users 102 may be a user of an e-commerce platform, a banking platform, a service providing platform, a bot platform, an educational platform, an organizational platform, a work management platform, an emailing platform, a database management platform, an entertainment platform, an informational platform, and the like. The computing devices 104 and 108 may be any electrical, electronic, electromechanical, and computing device. The computing devices 104 and 108 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, server, and the like. The system 110 may be implemented in hardware or a suitable combination of hardware and software. The system 110 or the centralized server 112 may be associated with entity(s) 114. The entity may include, but are not limited to, an e-commerce company, a company, a business, an outlet, a manufacturing unit, an enterprise, a facility, an organization, an educational institution, a secured facility, and the like.

Further, the system 110 may include a processor (not shown in FIG. 1), an Input/Output (I/O) interface (not shown in FIG. 1), and a memory (not shown in FIG. 1). The Input/Output (I/O) interface on the system 110 may be used to receive user inputs, from one or more computing devices 104-1, 104-2, . . . , 104-N (collectively referred to as computing devices 104 and individually referred to as computing device 104) associated with one or more users 102 (collectively referred as users 102 and individually referred as user 102).

Further, system 110 may also include other units such as a display unit, an input unit, an output unit, and the like, however the same are not shown in the FIG. 1, for the purpose of clarity. Also, in FIG. 1 only few units are shown, however, the system 110 or the network architecture 100 may include multiple such units or the system 110/network architecture 100 may include any such numbers of the units, obvious to a person skilled in the art or as required to implement the features of the present disclosure. The system 110 may be a hardware device including the processor 112 executing machine-readable program instructions to determine customer-facing inventory for online and offline environments. Execution of the machine-readable program instructions by the processor 112 may enable the proposed system 110 to cross-lingual adaptation using disentangled syntax and shared conceptual latent space for low-resource natural languages. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 112 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor may fetch and execute computer-readable instructions in the memory operationally coupled with the system 110 for performing tasks such as data processing, input/output processing, and/or any other functions. Any reference to a task in the present disclosure may refer to an operation being or that may be performed on data.

In the example that follows, assume that a user 102 or entity 114 of the system 110 desires to improve/add additional features for cross-lingual adaptation using disentangled syntax and shared conceptual latent space for low-resource natural languages. In this instance, the user 102 or entity 114 may include an administrator of a website, an administrator of an e-commerce site, an administrator of a social media site, an administrator of an e-commerce application/social media application/other applications, an administrator of media content (e.g., television content, video-on-demand content, online video content, graphical content, image content, augmented/virtual reality content, metaverse content), among other examples, and the like. The system 110 when associated with the electronic device or the centralized server 112 may include, but are not limited to, a touch panel, a soft keypad, a hard keypad (including buttons), and the like. For example, the user 102 may click a soft button on a touch panel of the electronic device or the centralized server 112 to perform one or more activities, but not limited to the like. As used herein, the graphical user interface may be a user interface that allows a user of the system 110 to interact with the system 110 through graphical icons and visual indicators, such as secondary notation, and any combination thereof, and may comprise of a touch panel configured to receive an input using a touch screen interface.

In an embodiment, the system 110 may convert one or more multi-lingual sentences received from a user, to one or more linearized constituency parse trees. For instance, the linearized constituency parse tree may be obtained by traversing a syntactic tree in a top-down order. Here, a syntactic tree (or constituency tree) may refer to a process of analyzing the sentences by breaking sentences down into sub-phrases also known as constituents. For instance, the constituency-based parse trees of constituency grammars (phrase structure grammars) distinguish between terminal and non-terminal nodes. Further, interior nodes may be labeled by the non-terminal categories of the grammar, while leaf nodes may be labeled by the terminal categories. For example, consider a syntactic structure of the English sentence “John hit the ball”. The parse tree may be the entire structure, starting from S and ending in each of the leaf nodes (John, hit, the, ball). The following abbreviations may be used in the tree, ‘S’ for sentence, the top-level structure in this example, ‘NP’ for noun phrase. The first (leftmost) ‘NP’, a single noun “John”, serves as the subject of the sentence. The second one is the object of the sentence. A ‘VP’ for verb phrase, which serves as the predicate, ‘V’ for verb. In this case, it's a transitive verb hit. A ‘D’ for determiner, in this instance the definite article “the”, ‘N’ for noun. Each node in the tree is either a root node, a branch node, or a leaf node. A root node is a node that does not have any branches on top of it. Within a sentence, there is only ever one root node. A branch node is a parent node that connects to two or more child nodes. A leaf node, however, is a terminal node that does not dominate other nodes in the tree. S is the root node, NP and VP are branch nodes, and John (N), hit (V), the (D), and ball (N) are all leaf nodes.

In an embodiment, the linearized constituency parse trees comprise one or more leaf nodes. In an embodiment, when the linearized constituency parse tree is not converted for low-resource natural languages, the sentence is directly passed to the syntactic encoder with auxiliary loss functions for disentanglement. The auxiliary loss functions may be based on marginal log-likelihood cross-lingual reconstruction and posterior distribution in the known language. Further, the natural languages may be suited using a modified attentive code position loss. The natural languages may be aligned using a syntactic attention mechanism.

In an embodiment, the system 110 may mask the one or more leaf nodes in the linearized constituency parse tree to separate semantic information in the one or more multi-lingual sentences. The semantic information may be held constant as the representation is already language invariant, which is used to reconstruct a sentence in the new language by learning respective syntactic information of the new language. For the new language, a specific linguistic rules/features may inform syntax adaptation, and semantic space may be used to align conceptual understanding. The disentangled semantic information may be language invariant and the syntactic information is language-specific, which is based on a pre-trained cross-lingual language model.

In an embodiment, the system 110 may pass the linearized constituency parse tree with the masked one or more leaf nodes, to a syntactic encoder for disentangling syntactic information in the one or more multi-lingual sentences. Thereafter, the system 110 may determine, from the syntactic information, if the one or more multi-lingual sentences include a new language to be learned, and the new language includes at least one of a new script relatively to a pre-existing language in a language model and a unique script with similarities in sentence structure corresponding to the pre-existing language. Further, the system 110 may transliterate, when the new language to be learned comprises the unique script, the syntactic information to the pre-existing language. In an embodiment, the transliteration includes applying an adaptation process to the transliteration and a pseudo translation for the new language adaptation in a low resource scenario. In an embodiment, the transliteration and pseudo translation may be performed to adjust the syntactic encoder to alignment loss for the new language, by building on a historical knowledge of a known language, and a related language.

In an embodiment, the system 110 may determine a conceptual similarity between the new language and the pre-existing language, upon the transliteration. Thereafter, the system 110 may output a conceptual understanding based on the determined conceptual similarity between the new language and the pre-existing language. For the new language, a specific linguistic rules/features may inform syntax adaptation, and semantic space may be used to align conceptual understanding.

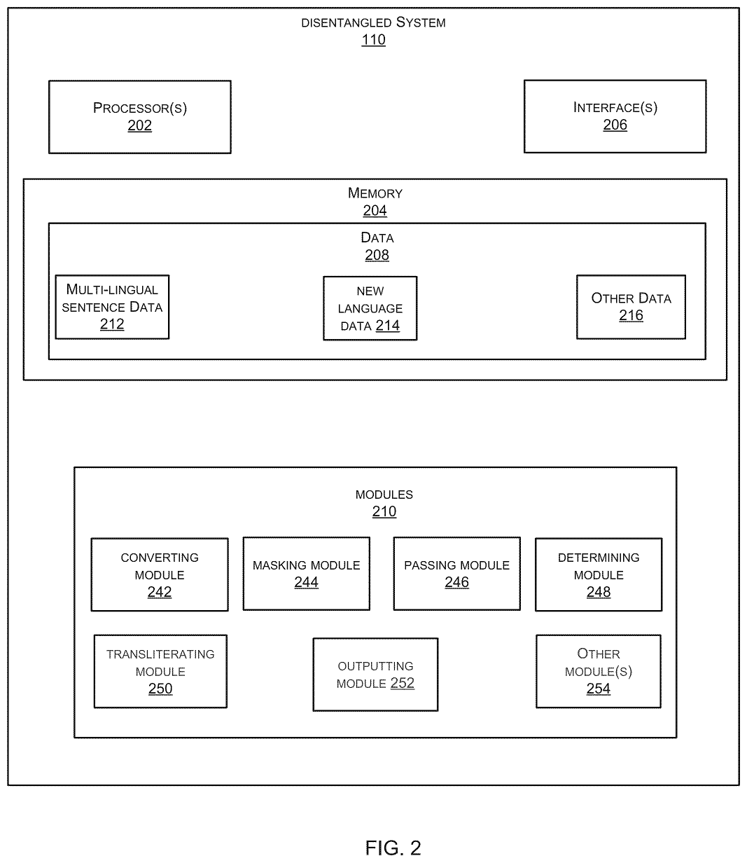

FIG. 2 illustrates a detailed block diagram representation of the proposed system 110, according to embodiments of the present disclosure. The system 110 may include a processor 202, a memory 204, and an Input/Output (I/O) interface 206. In some implementations, the system 110 may include data 208, and modules 210. As an example, the data 208 is stored in the memory 204 configured in the system 110 as shown in the FIG. 2.

In an embodiment, the data 208 may include multi-lingual sentence data 212, new language data 214, and other data 216. In an embodiment, the data 208 may be stored in the memory 204 in the form of various data structures. Additionally, the data 208 can be organized using data models, such as relational or hierarchical data models. The other data 216 may store data, including temporary data and temporary files, generated by the modules 210 for performing the various functions of the system 110.

In an embodiment, the modules 210, may include a converting module 342, a masking module 344, a passing module 346, a determining module 348, a transliterating module 350, an outputting module 352, and other modules 354.

In an embodiment, the data 208 stored in the memory 204 may be processed by the modules 210 of the system 110. The modules 210 may be stored within the memory 204. In an example, the modules 210 communicatively coupled to the processor 202 configured in the system 110, may also be present outside the memory 204, as shown in FIG. 2, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the converting module 342 may convert one or more multi-lingual sentences received from a user, to one or more linearized constituency parse trees. In an embodiment, the linearized constituency parse trees comprise one or more leaf nodes. In an embodiment, when the linearized constituency parse tree is not converted for low-resource natural languages, the sentence is directly passed to the syntactic encoder with auxiliary loss functions for disentanglement. The auxiliary loss functions may be based on marginal log-likelihood cross-lingual reconstruction and posterior distribution in the known language. Further, the natural languages may be suited using a modified attentive code position loss. The natural languages may be aligned using a syntactic attention mechanism. The converted one or more multi-lingual sentences received from the user 102 may be stored as the multi-lingual sentence data 212.

For instance, the linearized constituency parse tree may be obtained by traversing a syntactic tree in a top-down order. Here, syntactic tree (or constituency tree) may refer to a process of analyzing the sentences by breaking sentences down into sub-phrases also known as constituents. For instance, the constituency-based parse trees of constituency grammars (phrase structure grammars) distinguish between terminal and non-terminal nodes. Further, interior nodes may be labeled by the non-terminal categories of the grammar, while leaf nodes may be labeled by the terminal categories. For example, consider a syntactic structure of a English sentence “John hit the ball”. The parse tree may be the entire structure, starting from S and ending in each of the leaf nodes (John, hit, the, ball). The following abbreviations may be used in the tree, ‘S’ for sentence, the top-level structure in this example, ‘NP’ for noun phrase. The first (leftmost) ‘NP’, a single noun “John”, serves as the subject of the sentence. The second one is the object the sentence. A ‘VP’ for verb phrase, which serves as the predicate, ‘V’ for verb. In this case, it's a transitive verb hit. A ‘D’ for determiner, in this instance the definite article “the”, ‘N’ for noun. Each node in the tree is either a root node, a branch node, or a leaf node. A root node is a node that does not have any branches on top of it. Within a sentence, there is only ever one root node. A branch node is a parent node that connects to two or more child nodes. A leaf node, however, is a terminal node that does not dominate other nodes in the tree. S is the root node, NP and VP are branch nodes, and John (N), hit (V), the (D), and ball (N) are all leaf nodes.

In an embodiment, the masking module 344 may mask the one or more leaf nodes in the linearized constituency parse tree to separate semantic information in the one or more multi-lingual sentences. The semantic information may be held constant as the representation is already language invariant, which is used to reconstruct a sentence in the new language by learning respective syntactic information of the new language. For the new language, a specific linguistic rules/features may inform syntax adaptation, and semantic space may be used to align conceptual understanding. The disentangled semantic information may be language invariant and the syntactic information is language-specific, which is based on a pre-trained cross-lingual language model.

In an embodiment, the passing module 346 may pass the linearized constituency parse tree with the masked one or more leaf nodes, to a syntactic encoder for disentangling syntactic information in the one or more multi-lingual sentences. Thereafter, the determining module 348 may determine, from the syntactic information, if the one or more multi-lingual sentences include a new language to be learned, and the new language includes at least one of a new script relatively to a pre-existing language in a language model and a unique script with similarities in sentence structure corresponding to the pre-existing language. The new language to be learned may be stored as the new language data 214.

In an embodiment, the transliterating module 350 may transliterate, when the new language to be learned comprises the unique script, the syntactic information to the pre-existing language. In an embodiment, the transliteration includes applying an adaptation process to the transliteration and a pseudo translation for the new language adaptation in a low resource scenario. In an embodiment, the transliteration and pseudo translation may be performed to adjust the syntactic encoder to alignment loss for the new language, by building on a historical knowledge of a known language, and a related language.

In an embodiment, the determining module 348 may determine a conceptual similarity between the new language and the pre-existing language, upon the transliteration. Thereafter, the outputting module 352 may output a conceptual understanding based on the determined conceptual similarity between the new language and the pre-existing language. For the new language, a specific linguistic rules/features may inform syntax adaptation, and semantic space may be used to align conceptual understanding.

### Exemplary Scenario

Consider, a scenario, where a user utters or types as, for example, my name is “ABC” in English language and next day/next hour the same or any other user utters or types as, for example, “Mera nam ABC hai” (i.e., [symbol] ABC [symbol] ) in regional language for example, Hindi. However, the meaning of both aforementioned sentences is the same, but in different languages. The system 110 may obtain such sentences in different languages, which means the same, and then coordinates in different orders, and the representation is different. A language model (not shown) of the system 110, may understand different languages and try to distinguish between the languages, the language models distinguish between semantic meaning and syntactical meaning. The system 110 may code language features separately and meaningfully, with the language model comprising multiple languages, for example, five languages. Now the system 110 may need to be added with a sixth language. The sixth language may need not be trained to the system 110 or the language model of the system 110. The system 110 may need not start from scratch to learn the sixth new language. The system 110 may learn how to encode the meaning in the sixth language. The system 110 may learn the different language (i.e., the sixth language) and how the grammar and the different language work, which includes learning the same syntactical meaning and not the semantic meaning.

The language module may be a cross-lingual module, which can understand both English and Hindi. This model would then come up with the numerical representation for the aforementioned sentences. One representation for the English sentence and one representation for Hindi. As there is no difference between the sentences, the numerical representation may be one.

Initially, the system 110 may output that there is a slight difference in the language, and the system does not understand that it is due to the difference in the language and not due to meaning. However, the system 110 needs to understand that, if there is any difference between these two sentences, it will be because of the language representation. There may be different mathematical representations, for these sentences and convey that these sentences are exactly the same. Hence, the system 110 may distinguish between meaning and language, which can be used to learn a new language.

In another scenario, consider the user provides ten languages, which has ten sentences in Spanish and ten sentences in English. The sentences in both the languages (Spanish and English) mean the same. The system 110 may know Spanish. However, the system 110 can only focus on learning the grammar of Spanish. The system 110 may only know the grammar of the Spanish. For since, how does Spanish pronounce, what are the words, how is the sentence structure, and the like? The system 110 can pick sentences in English and in Spanish to focus on the differences in grammar of both English and Spanish, which helps in reducing the training time of the system 110 and computational cost. For example, Indian languages are very similar in terms of sentence structure, in terms of direct correlations in words, such as Punjabi, and Hindi. These analytics are very similar in terms of sentence, structure, and words that have been used.

In another instance. the language model may already have about a hundred languages to some level, but even. For example, Spanish and English, may come from Latin families. So, to learn a language and the family, the system 110 may some resources, which language belongs to family. The user may not deal with Hindi with Spanish. The user would probably use English with Spanish. So, this kind of pairing may be used in the system 110 such as the same family which has similar sentence structure and have a similar script.

The aforementioned scenario may be a scenario of a syntactic-semantic space disentanglement. The system 110 may extract disentangled semantic (i.e., language invariant) and syntactic (i.e., language-specific) spaces from, for example, a pre-trained cross-lingual language model. The system 110 may use, for example, an encoder-decoder Variational Auto Encoders (VAEs) architecture. The system 110 may include a constituency tree approach. In this approach, the system 110 may convert input sentences (i.e., multilingual) to the linearized constituency parse trees. Further, the system 110 may mask leaf nodes in the parse tree to ensure semantic information is separated, and passed to the syntactic encoder. Further, the loss functions based on marginal log-likelihood for cross-lingual reconstruction and posterior distribution in KL terms may be primary. Attentive code position loss may have to be modified to suit natural languages which are not as rigid as programming languages. Alternatively, the system 110 may use a syntactic attention mechanism for alignment in natural languages. Further, the system 110 may use a multi-task approach. For instance, in low-resource scenarios, creating a constituency tree may not be possible. In this instance, just the sentence alone may be passed to the encoder-decoder architecture with auxiliary loss functions for disentanglement.

Further, the system 110 may include language adaptation for the same script. In this scenario, the new language to be learned has the same script as the pre-existing language in Language Model (LM). Further, the system 110 may include language adaptation for a different script. Based on the success of transliteration, the adaptation process could apply transliteration and pseudo translation for new language adaptation in a low-resource scenario. This process of transliteration and the pseudo translation may help alignment loss to adjust the syntactic encoder for the new language by building on past knowledge of a known, related language. Further, semantics may be held constant, since the representation is already language invariant and the system 110 may reconstruct a sentence in the new language by learning syntactic representation alone of a new language.

The system 110 may extract a language invariant semantic and syntax space from cross-lingual embeddings of a pre-trained model (for languages already included). Rationale: a language invariant semantic space may ensure that the space contains information free of linguistic influence and only consisting of abstract concepts and semantics. The implication of such a space may also be, given that a sequence of identical language translations, their difference would only lie in the linguistic embedding space. This is empirically validated in the context of programming languages in through experiments on semantic equivalence for semantically identical code snippets. This directly influences the word embedding alignment goal, potentially improving downstream cross-lingual task performance. It would also help with the identification of possible problem areas; whether the LM is struggling with syntactic understanding or semantic understanding. Intuitively and empirically (on tasks like paraphrase pair identification) sentence embedding models that learn to disentangle semantics and syntax yield more robust performance on datasets with high syntactic variation. Hence, the system 110 may be expected with similar performance gains in cross-lingual semantic understanding-based tasks.

Further, the system 110 may improve low-resource task performance, especially in new language adaptation. Rationale: Besides improving performance for already learnt languages, a disentangled space also seems beneficial for low-resource scenarios. A disentangled model may outperform a comparable model using only half the training set. Besides this, the disentangled spaces of the system 110 may help low-resource language adaptation. The system 110 may analyze different training setups such as dictionary-based or parallel corpus-based methods. However, it makes intuitive sense to hypothesize that a disentangled space would aid interpretable embedding alignment for both syntax and semantics. Specific linguistic rules/features can inform syntax adaptation for a new language while semantic space can be used to align concept understanding. Assuming orthogonal semantic and syntax spaces, we can also better investigate through ablation studies the importance of syntactic features like script relatedness and structure relatedness for syntactic language transfer as a future research direction.

Furthermore, the system 110 may provide the shared semantic space which may be generalizable in terms of monolingual and multilingual tasks. Rationale: while cross-lingual alignment is important, so is the ability to perform well on different tasks in a single language. Since, the multilingual capability is expected, the monolingual performance may need to be reflected for all languages covered by the LM, post new language adaptation. This would confirm whether the semantic representation retains its language invariance even after fine-tuning on downstream tasks for a single language. Such a result would be a significant development for zero-shot transfer tasks and the utility of dissociated latent spaces. The system 100 may improve systematic generalization. Rationale: there may be abundant evidence showing that current neural networks struggle with a systematic generalization which led to attempts at “making infinite use of finite means”. The system 110 may separate syntax and semantics and provide improved compositional generalization on a scan dataset. Downstream tasks such as open domain question answering may also benefit from systematic generalization at different levels of complexity, specifically by improving the retrieval component. Similarity scoring on questions and document embeddings (a key component of retrieving and read architectures) may also benefit when the semantic and syntactic comparison is separated.

The system may provide low resource language transfer, word embedding alignment for improved cross-lingual performance, generalizable (language invariant) concept learning in cross-lingual models, and systematic generalization in neural networks using the disentangled syntactical (i.e., language-specific) and conceptual (i.e., language invariant) latent space learning and leveraging language relatedness and conceptual similarity The system 110 uses concept/semantic matching between parallel multilingual corpora while leveraging language relatedness (syntactically related) to learn low-resource language syntax. Such a disentangled cross-lingual learning paradigm may have the potential to also improve downstream tasks such as Question Answering (QA) and Natural Language Inference (NLI) by directly influencing word embedding alignment, compositional generalization, and language invariant conceptual understanding.

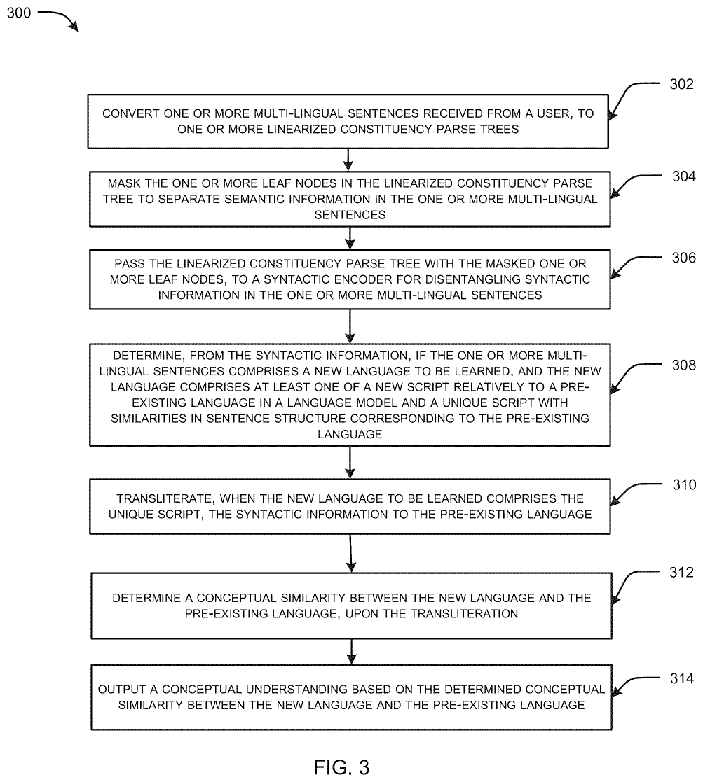

FIG. 3 illustrates a flow chart depicting a method 300 of cross-lingual adaptation using disentangled syntax and shared conceptual latent space for low-resource natural languages, according to embodiments of the present disclosure.

At block 302, the method 300 includes, converting, by a processor 202, one or more multi-lingual sentences received from a user, to one or more linearized constituency parse trees. The linearized constituency parse trees comprise one or more leaf nodes.

At block 304, the method 300 includes masking, by the processor 202, the one or more leaf nodes in the linearized constituency parse tree to separate semantic information in the one or more multi-lingual sentences.

At block 306, the method 300 includes passing, by the processor 202, the linearized constituency parse tree with the masked one or more leaf nodes, to a syntactic encoder for disentangling syntactic information in the one or more multi-lingual sentences.

At block 308, the method 300 includes determining, by the processor 202, from the syntactic information, if the one or more multi-lingual sentences comprise a new language to be learned, and the new language comprises at least one of a new script relatively to a pre-existing language in a language model and a unique script with similarities in sentence structure corresponding to the pre-existing language.

At block 310, the method 300 includes transliterating, by the processor 202, when the new language to be learned comprises the unique script, the syntactic information to the pre-existing language, wherein the transliteration comprises applying an adaptation process to the transliteration and a pseudo translation for the new language adaptation in a low resource scenario.

At block 312, the method 300 includes determining, by the processor, a conceptual similarity between the new language and the pre-existing language, upon the transliteration.

At block 314, the method 300 includes outputting, by the processor 202, a conceptual understanding based on the determined conceptual similarity between the new language and the pre-existing language.

The order in which the method 300 are described is not intended to be construed as a limitation, and any number of the described method blocks may be combined or otherwise performed in any order to implement the method 300 or an alternate method. Additionally, individual blocks may be deleted from the method 300 without departing from the spirit and scope of the present disclosure described herein. Furthermore, the method 300 may be implemented in any suitable hardware, software, firmware, or a combination thereof, that exists in the related art or that is later developed. The method 300 describe, without limitation, the implementation of the system 110. A person of skill in the art will understand that method 300 may be modified appropriately for implementation in various manners without departing from the scope and spirit of the disclosure.

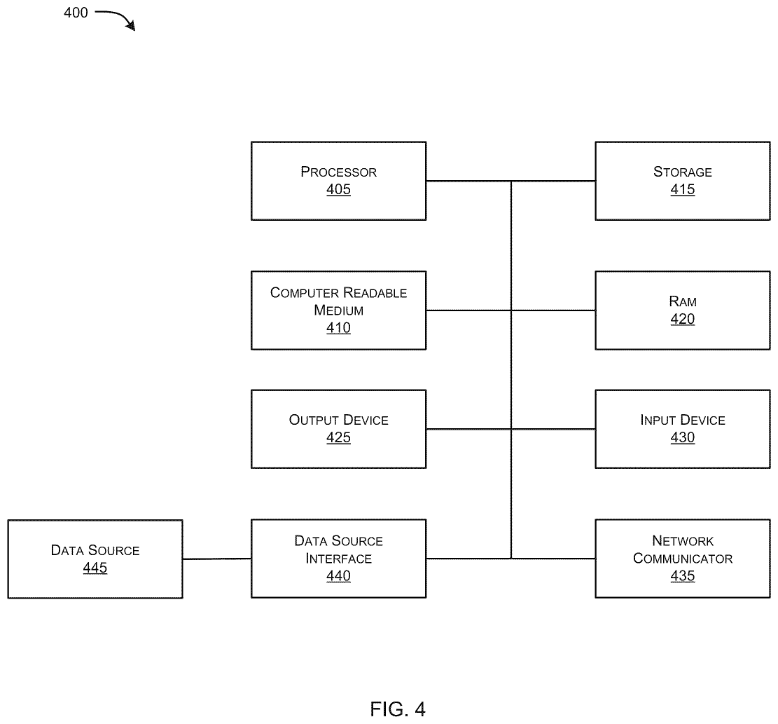

FIG. 4 illustrates a hardware platform 400 for implementation of the disclosed system 110, according to an example embodiment of the present disclosure. For the sake of brevity, the construction and operational features of the system 110 which are explained in detail above are not explained in detail herein. Particularly, computing machines such as but not limited to internal/external server clusters, quantum computers, desktops, laptops, smartphones, tablets, and wearables which may be used to execute the system 110 or may include the structure of the hardware platform 400. As illustrated, the hardware platform 400 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 400 may be a computer system such as the system 210 that may be used with the embodiments described herein. The computer system may represent a computational platform that includes components that may be in a server or another computer system. The computer system may execute, by the processor 405 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 405 that executes software instructions or code stored on a non-transitory computer-readable storage medium 410 to perform methods of the present disclosure. The software code includes, for example, instructions to gather data and documents and analyze documents. In an example, the modules 304, may be software codes or components performing these steps.

The instructions on the computer-readable storage medium 410 are read and stored the instructions in storage 415 or in random access memory (RAM). The storage 415 may provide a space for keeping static data where at least some instructions could be stored for later execution. The stored instructions may be further compiled to generate other representations of the instructions and dynamically stored in the RAM such as RAM 420. The processor 405 may read instructions from the RAM 420 and perform actions as instructed.

The computer system may further include the output device 425 to provide at least some of the results of the execution as output including, but not limited to, visual information to users, such as external agents. The output device 425 may include a display on computing devices and virtual reality glasses. For example, the display may be a mobile phone screen or a laptop screen. GUIs and/or text may be presented as an output on the display screen. The computer system may further include an input device 430 to provide a user or another device with mechanisms for entering data and/or otherwise interacting with the computer system. The input device 430 may include, for example, a keyboard, a keypad, a mouse, or a touchscreen. Each of these output devices 425 and input device 430 may be joined by one or more additional peripherals. For example, the output device 425 may be used to display the results such as bot responses by the executable chatbot.

A network communicator 435 may be provided to connect the computer system to a network and in turn to other devices connected to the network including other clients, servers, data stores, and interfaces, for instance. A network communicator 435 may include, for example, a network adapter such as a LAN adapter or a wireless adapter. The computer system may include a data sources interface 440 to access the data source 445. The data source 445 may be an information resource. As an example, a database of exceptions and rules may be provided as the data source 445. Moreover, knowledge repositories and curated data may be other examples of the data source 445.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as a limitation.

### ADVANTAGES OF THE PRESENT DISCLOSURE

The present disclosure provides a method and a system for cross-lingual adaptation using disentangled syntax and shared conceptual latent space for low-resource natural languages.

The present disclosure provides a method and a system for extracting a language invariant semantic and syntax space from cross-lingual embeddings of a pre-trained model (for languages already included), based on syntactic-semantic space disentanglement.

The present disclosure improves low-resource task performance, especially new language adaptation.

The present disclosure enables a shared semantic space to be generalizable in terms of monolingual and multilingual tasks, and enables a systematic generalization.

The present disclosure provides constituency tree approach by convert (multilingual) input sentences to linearized constituency parse trees, and masks leaf nodes in the parse tree to ensure semantic information is separated, passed to the syntactic encoder.

The present disclosure provides a multi-task approach in low resource scenarios, in which creating a constituency tree is not possible.

The present disclosure enables a language adaptation of the same script, in which the new language to be learned has the same script as the pre-existing language in the language model, and a different script.

The present disclosure enables transliteration and pseudo translation for the different scripts, to help alignment loss to adjust the syntactic encoder for the new language by building on past knowledge of a known, related language.

The present disclosure addresses low resource language transfer, word embedding alignment for improved cross-lingual performance, generalizable (language invariant) concept learning in cross-lingual models, and systematic generalization in neural networks using the disentangled syntactical (language-specific) and conceptual (language invariant) latent space learning and leveraging language relatedness and conceptual similarity. This enables efficient, interpretable language adaptation on a pre-trained language model.

The present disclosure enables the use of concept/semantic matching between parallel multilingual corpora while leveraging language relatedness (syntactically related) to learn low-resource language syntax. Such a disentangled cross-lingual learning paradigm has the potential to also improve downstream tasks like Question Answering (QA) and natural language inference (NLI) by directly influencing word embedding alignment, compositional generalization, and language invariant conceptual understanding.

We claim:

1. A method for cross-lingual adaptation using disentangled syntax and shared conceptual latent space for low-resource natural languages, the method comprising:
converting, by a processor (202) associated with a disentangled system (110), one or more multi-lingual sentences received from a user (102), to one or more linearized constituency parse trees, wherein the linearized constituency parse trees comprise one or more leaf nodes;
masking, by the processor (202), the one or more leaf nodes in the linearized constituency parse tree to separate semantic information in the one or more multi-lingual sentences;
passing, by the processor (202), the linearized constituency parse tree with the masked one or more leaf nodes, to a syntactic encoder for disentangling syntactic information in the one or more multi-lingual sentences;
determining, by the processor (202), from the syntactic information, if the one or more multi-lingual sentences comprise a new language to be learned, and the new language comprises at least one of a new script relatively to a pre-existing language in a language model and a unique script with similarities in sentence structure corresponding to the pre-existing language;
transliterating, by the processor (202), when the new language to be learned comprises the unique script, the syntactic information to the pre-existing language, wherein the transliteration comprises applying an adaptation process to the transliteration and a pseudo translation for the new language adaptation in a low resource scenario;
determining, by the processor (202), a conceptual similarity between the new language and the pre-existing language, upon the transliteration; and
outputting, by the processor (202), a conceptual understanding based on the determined conceptual similarity between the new language and the pre-existing language.

2. The method as claimed in claim 1, wherein, when the linearized constituency parse tree is not converted for low-resource natural languages, the sentence is directly passed to the syntactic encoder with auxiliary loss functions for disentanglement.

3. The method as claimed in claim 1, wherein the transliteration and pseudo translation are performed to adjust the syntactic encoder to alignment loss for the new language, by building on a historical knowledge of a known language, and a related language.

4. The method as claimed in claim 1, wherein the semantic information is held constant as the representation is already language invariant, which is used to reconstruct a sentence in the new language by learning respective syntactic information of the new language.

5. The method as claimed in claim 1, wherein the auxiliary loss functions are based on marginal log-likelihood cross-lingual reconstruction and posterior distribution in the known language.

6. The method as claimed in claim 1, wherein the natural languages are suited using a modified attentive code position loss, wherein the natural languages are aligned using a syntactic attention mechanism.

7. The method as claimed in claim 1, wherein, for the new language a specific linguistic rules/features informs syntax adaptation, and semantic space is used to align conceptual understanding.

8. The method as claimed in claim 1, wherein the disentangling semantic information is language invariant and the syntactic information is language-specific, which is based on a pre-trained cross-lingual language model.

9. A disentangled system (110) for cross-lingual adaptation using disentangled syntax and shared conceptual latent space for low-resource natural languages, the disentangled system (110) comprising:
a processor (202);
a memory (204) coupled to the processor (202), wherein the memory (204) comprises processor-executable instructions, which on execution, causes the processor (202) to:
convert one or more multi-lingual sentences received from a user (102), to one or more linearized constituency parse trees, wherein the linearized constituency parse trees comprise one or more leaf nodes;
mask the one or more leaf nodes in the linearized constituency parse tree to separate semantic information in the one or more multi-lingual sentences;
pass the linearized constituency parse tree with the masked one or more leaf nodes, to a syntactic encoder for disentangling syntactic information in the one or more multi-lingual sentences;
determine, from the syntactic information, if the one or more multi-lingual sentences comprise a new language to be learned, and the new language comprises at least one of a new script relatively to a pre-existing language in a language model and a unique script with similarities in sentence structure corresponding to the pre-existing language;
transliterate, when the new language to be learned comprises the unique script, the syntactic information to the pre-existing language, wherein the transliteration comprises applying an adaptation process to the transliteration and a pseudo translation for the new language adaptation in a low resource scenario;
determine a conceptual similarity between the new language and the pre-existing language, upon the transliteration; and
output a conceptual understanding based on the determined conceptual similarity between the new language and the pre-existing language.

10. The disentangled system (110) as claimed in claim 9, wherein, when the linearized constituency parse tree is not converted for low-resource natural languages, the sentence is directly passed to the syntactic encoder with auxiliary loss functions for disentanglement.

11. The disentangled system (110) as claimed in claim 9, wherein the transliteration and pseudo translation are performed to adjust the syntactic encoder to alignment loss for the new language, by building on a historical knowledge of a known language, and a related language.

12. The disentangled system (110) as claimed in claim 9, wherein the semantic information is held constant as the representation is already language invariant, which is used to reconstruct a sentence in the new language by learning respective syntactic information of the new language.

13. The disentangled system (110) as claimed in claim 9, wherein the auxiliary loss functions are based on marginal log-likelihood cross-lingual reconstruction and posterior distribution in the known language.

14. The disentangled system (110) as claimed in claim 9, wherein the natural languages are suited using a modified attentive code position loss, wherein the natural languages are aligned using a syntactic attention mechanism.

15. The disentangled system (110) as claimed in claim 9, wherein, for the new language a specific linguistic rules/features, informs syntax adaptation, and semantic space is used to align conceptual understanding.

16. The disentangled system (110) as claimed in claim 9, wherein the disentangling semantic information is language invariant and the syntactic information is language-specific, which is based on a pre-trained cross-lingual language model.
